(19) United States
(12) Patent Application Publication
(10) Pub. No.: US 2005/0072631 A1
(43) Pub. Date: Apr. 7, 2005

(54) Climbing tree stand

(76) Inventor: Robert B. Tracey, Kennesaw, GA (US)

Correspondence Address: Richard C. Litman, LITMAN LAW OFFICES, LTD., P.O. Box 15035, Arlington, VA, 22215, US

(21) Appl. No.: 10/958,259

(22) Filed: Oct. 6, 2004

Related U.S. Application Data
(60) Provisional application No. 60/508,870, filed on Oct. 7, 2003.

(51) Int. Cl. E06C 5/00

(52) U.S. Cl. 182/127

(57) ABSTRACT

The climbing tree stand is a tree stand including a drive wheel assembly fixed onto a support frame such that the climbing tree stand may be self propelled along the trunk of a tree. A top guide secures the upper end of the support frame about the trunk of a tree in position for climbing, and a bottom guide maintains the support frame's lower end in alignment with the tree trunk for climbing. A platform for sitting or standing is attached to the lower end of the support frame. A climbing wheel assembly includes at least one climbing wheel adapted for engagement with the a tree, and a drive mechanism including a ratchet lever arm operatively coupled the at least one climbing wheel such that operation of the lever arm to rotate the at least one climbing wheel propels the climbing tree stand along the tree trunk tree.

### CROSS-REFERENCE TO RELATED APPLICATION

This application claims the benefit of U.S. Provisional Patent Application Ser. No. 60/508,870, filed Oct. 7, 2003.

### BACKGROUND OF THE INVENTION

1. Field of the Invention

The present invention relates to tree stands for hunters, outdoor enthusiasts and others using an elevated observation platform. More particularly, the invention is a climbing tree stand that employs friction wheel driven by a foot pedal to propel the tree stand up and down a tree.

2. Description of the Related Art

Tree stands are often used by hunters, and others, to provide an elevated observation platform, where the user may sit or stand in a tree elevated above the ground. It is useful for hunters, naturalists, photographers, and others to have, a comfortable perch elevated discreetly out of sight of wildlife while waiting for the wildlife to come into view.

Fixed tree stands, such as elevated platforms that are placed into position in a tree and accessed by a ladder or other means for climbing the tree, are numerous and have been in use for a long time. Anchored to a tree, these platforms provide the advantage of elevation, but lack flexibility in use. Once affixed to the tree, the platform cannot be readily removed from the tree and relocated to another location.

Climbing tree stands address the problem of relocation by providing a portable device that can be elevated into position by climbing the device up the tree trunk. Climbing tree stands typically comprise two frames that are used in concert to climb the tree. Each frame fits around the tree trunk in a manner such that, when weighted by the hunter, the frame engages the tree trunk sufficiently to support the hunter's weight. By alternately supporting himself on the lower frame while elevating the upper frame, and then supporting himself on the upper frame while elevating the lower, the hunter uses the device to climb the tree. Once positioned, one of the frames (usually the upper frame) is used as the elevated platform.

U.S. Pat. No. 6,308,801, issued on Oct. 30, 2001 to J. D. Futch, illustrates this type of climbing tree stand. Such a portable climbing tree stand helps to address the problem of relocation and reorienting of the stand since the stand can be brought down from the tree and relocated or raised back up the same tree in a different orientation. Such a tree stand, however, can be physically taxing as the climber alternately hoists his weight along with the lower frame while supported by the upper frame, and then lifts the upper frame while standing on the lower.

The tree climbing apparatus disclosed by U.S. Pat. No. 4,593,789, issued on Jun. 10, 1986 to B. Treants, eliminates the second cooperating climbing platform by employing a winch to elevate the tree stand platform into position. A rope is suspended from a point elevated in the tree, such as a high branch or limb. The rope may be secured at the bottom of the tree and looped over the tree limb. The tree platform is positioned around the tree trunk, suspended on the rope, and elevated by the winch. A foot pedal operated braking and locking mechanism engages the tree trunk during climbing, and when positioned at the desired height in order to prevent the platform from falling. While this apparatus eliminates the need for a second cooperating climbing platform used by most climbing tree stands, it introduces the need to place a rope in the tree for operation of the winch. This seems to complicate, rather than simplify, the process of using the tree stand, since it entails the need to either climb the tree to place the rope, or the need to throw the rope up and over a tree limb, thus limiting the useful height of the stand by one's ability to throw the rope or one's ability and willingness to climb the tree.

A jack, such as the jack disclosed in U.S. Pat. No. 2,849,211, issued on Aug. 26, 1958 to C. E. Shoesmith, provides a climbing mechanism in which two cooperating climbing members are actuated by a single lever to move the jack upwards along a stud or a pole. A similar mechanism is used to raise and lower construction site scaffolding and the like. Another such jack is shown in the U.S. Pat. No. 4,463,828, issued on Aug. 7, 1984 to C. Anderson. While providing a useful mechanism for traveling upwards along a pole for jacking or scaffolding tasks, jacks of this type are typically limited to use on a specific size and shape of a pole. The Shoesmith jack provides for no adjustment to accommodate climbing of poles of different sizes. The Anderson jack also does not allow for adjustment for size and, additionally, is intended specifically for use with a specialized scaffolding pole having a rubberized surface formed on a side. Because they cannot be adjusted to accommodate differently sized or irregularly shaped poles or trees, which are differently sized and irregularly shaped by nature, these jacks are not suited for use as a tree climbing mechanism.

None of the above inventions and patents, taken either singly or in combination, is seen to describe the instant invention as claimed. Thus a climbing tree stand solving the aforementioned problems is desired.

### SUMMARY OF THE INVENTION

The climbing tree stand of the present invention provides a simplified device for climbing a tree. The climbing tree stand is a tree stand including a drive wheel assembly fixed onto a support frame such that the climbing tree stand may be self propelled along the trunk of a tree. A top guide secures the upper end of the support frame about the trunk of a tree in position for climbing, and a bottom guide maintains the support frame's lower end in alignment with the tree trunk for climbing. A platform for sitting or standing is attached to the lower end of the support frame. A climbing wheel assembly includes at least one climbing wheel adapted for engagement with the a tree, and a drive mechanism including a ratchet lever arm operatively coupled the at least one climbing wheel such that operation of the lever arm to rotate the at least one climbing wheel propels the climbing tree stand along the tree trunk tree.

These and other features of the present invention will become readily apparent upon further review of the following specification and drawings.

### BRIEF DESCRIPTION OF THE DRAWINGS

FIG. 1 is an environmental, perspective view of a climbing tree stand according to the present invention.

FIG. 2 is a perspective view of a climbing tree stand according to the present invention, disassembled and folded for transportation.

FIG. 3 is a side view of a climbing tree stand according to the present invention.

FIG. 4 is a top view of a climbing tree stand according to the present invention.

FIG. 5 is a perspective view of a drive wheel assembly according to the present invention.

FIG. 6 is an exploded view of the drive wheel assembly seen in FIG. 5.

Similar reference characters denote corresponding features consistently throughout the attached drawings.

### DETAILED DESCRIPTION OF THE PREFERRED EMBODIMENTS

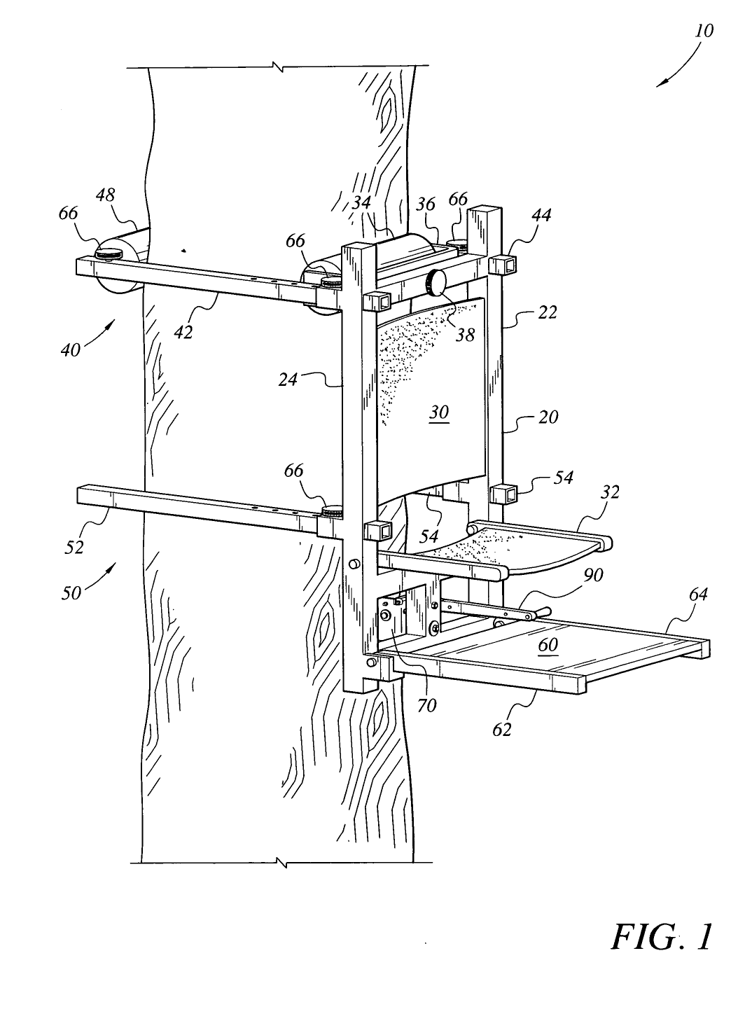

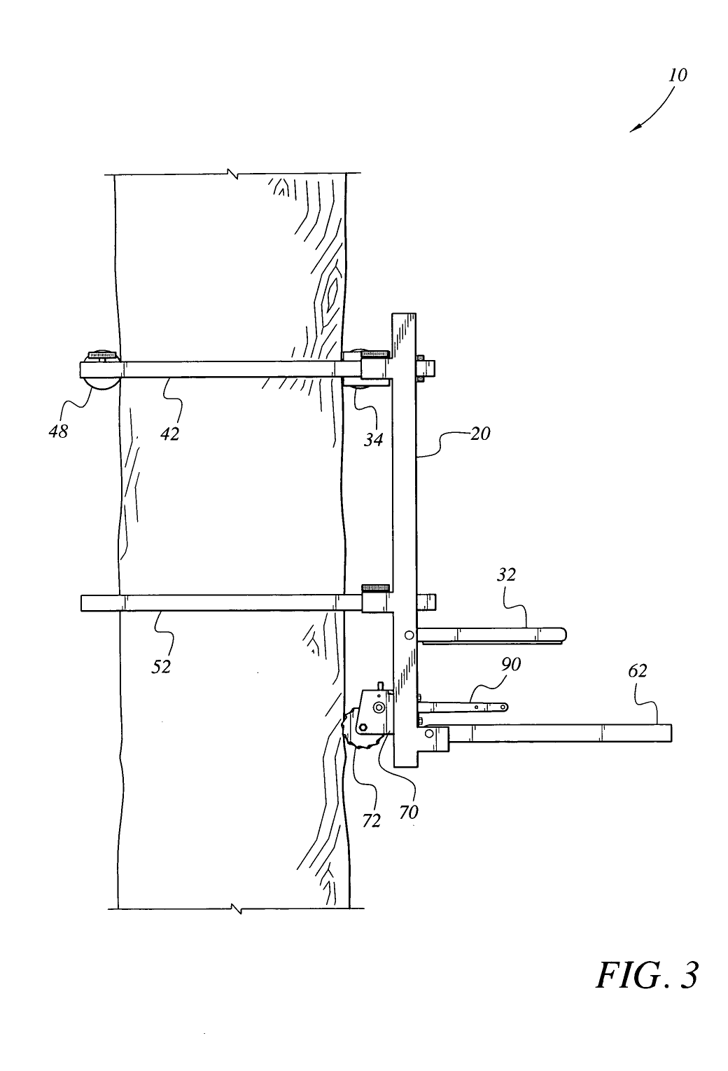

The present invention is a climbing tree stand, designated generally as 10 in the drawings. Referring to FIGS. 1-4, the climbing tree stand 10 comprises a support frame 20 that is engaged about a tree trunk by an upper guide 40 and a lower guide 50, and also includes drive wheel assembly 70. A seat back 30 and a seat bottom 32 are disposed on the support frame 20. Seat bottom 32 is hinged so it may be folded for storage and transportation of the climbing tree stand 10.

The support frame 20 is comprised of parallel first and second rails 22, 24 that form the vertical sides of the support frame 20. The first and second rails 22, 24 are joined near the top by a top cross bar 26 and joined near the bottom by a bottom cross bar 28 to form a generally rectangular frame.

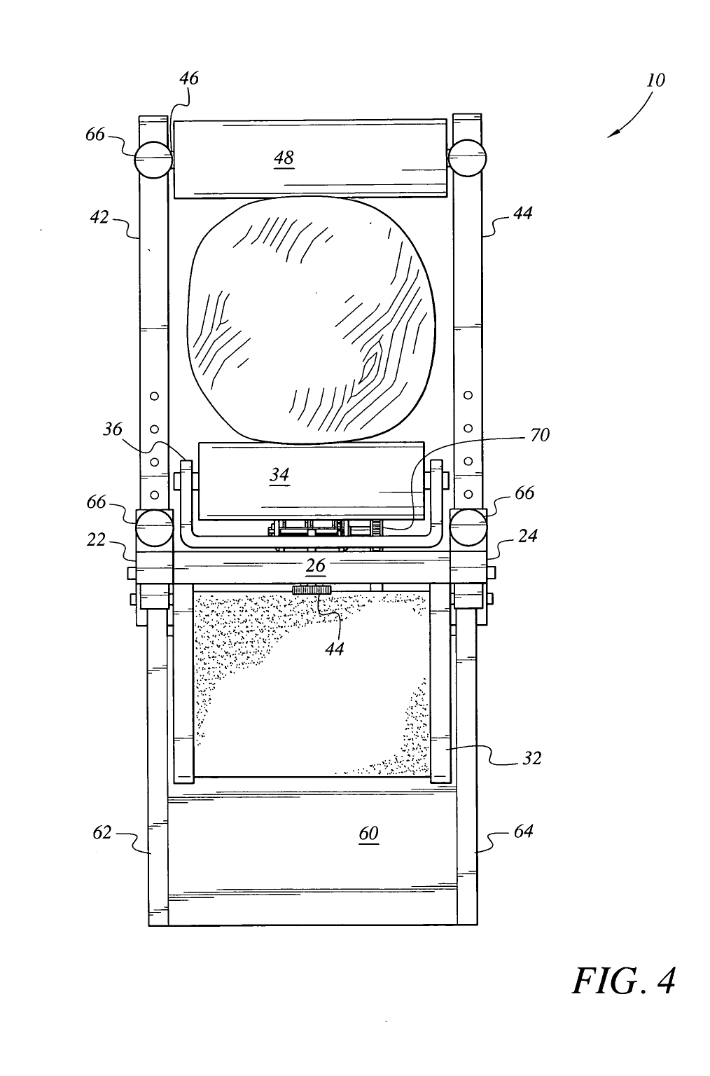

The upper guide 40 functions to secure the upper end of the support frame about a tree trunk, holding the climbing tree stand 10 in position for climbing the tree. The upper guide 40 is comprised of a first upper guide arm 42 and a second upper guide arm 44 that are removably joined to the support frame 20 near the top of the support frame 20, and that extend rearward from the support frame 20. The first and second upper guide arms 42, 44 are held in place by removable pins 66. A roller 48 is supported on a roller shaft 46 (shown in FIG. 4) that extends between the first guide arm 42 and the second guide arm 44, joining the guide arm ends opposite the support frame 20. The roller shaft 46 is preferably pivotally joined to one guide arm and affixed to the other guide arm by a removable pin 66 so that the roller 48 may be pivoted out of the way while the upper guide 40 is positioned around the tree, and then closed once the upper guide 40 is in place around the tree.

An adjustable roller 34 is disposed on the top cross bar 26 of the support frame 20. The adjustable roller 34 is supported by an adjustable bracket 36, which is fastened to the top cross bar 26 by an adjustment screw 38. The adjustable roller 34 allows the climbing tree stand 10 to be fitted around tree trunks of variable size.

The lower guide 50 functions to maintain the lower end of the support frame in proper alignment with the tree trunk, maintaining the climbing tree stand 10 in the proper position relative to the tree for climbing. The lower guide 50 is comprised of a first lower guide arm 52 and a second lower guide arm 54 that are removably joined to the support frame 20 near the bottom of the support frame 20, and that extend rearward from the support frame 20. The first and second lower guide arms 52, 54 are held in place by removable pins 66.

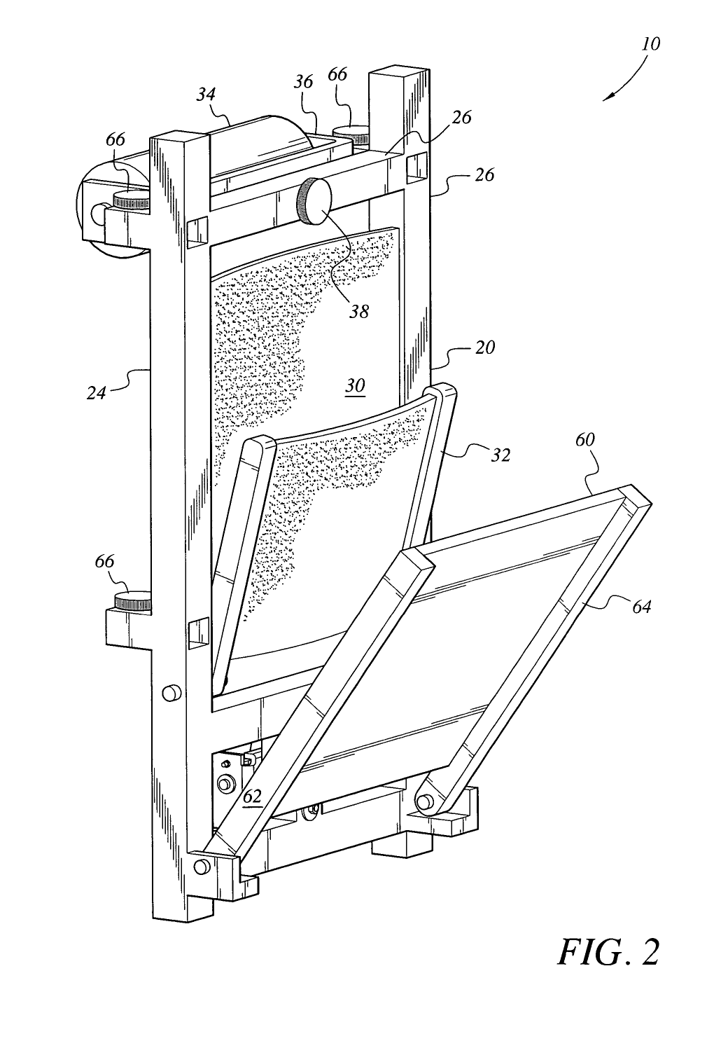

A platform 60 is disposed near the bottom of the support frame 20. The platform 60 is supported by first and second platform rails 62, 64 which are pivotally attached to the support frame 20 by hinges, so that the platform 60 can be folded for transportation and storage. The climbing tree stand is shown in FIG. 2 with the seat bottom 32 and the platform 60 folded against support frame 20, and the upper and lower guides 40, 50 removed, for transportation and storage.

The drive wheel assembly 70 is disposed at the bottom of the support frame 20. The drive wheel assembly 70 includes at least one toothed or spiked climbing wheel 72 adapted to engage with a tree trunk when the climbing tree stand 10 is positioned around the tree trunk for operation. The climbing wheels 72 grip the tree trunk, providing sufficient traction to propel the climbing tree stand 10 up and down the tree trunk as the at least one climbing wheel 72 is turned by the drive wheel assembly 70.

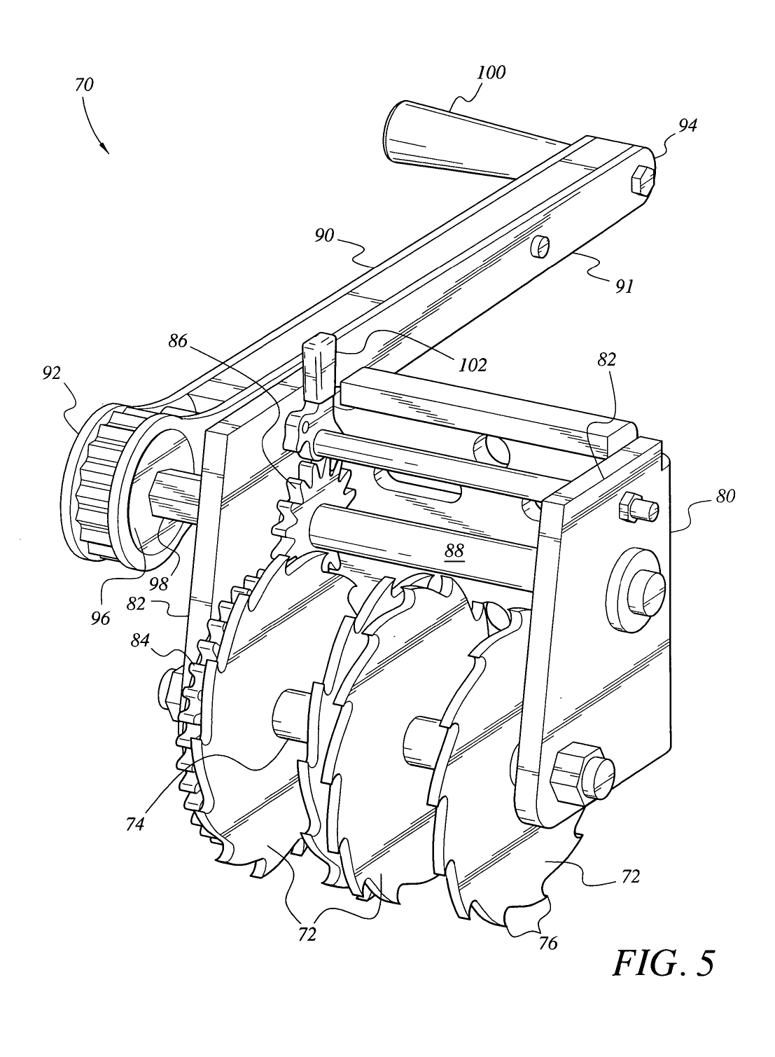

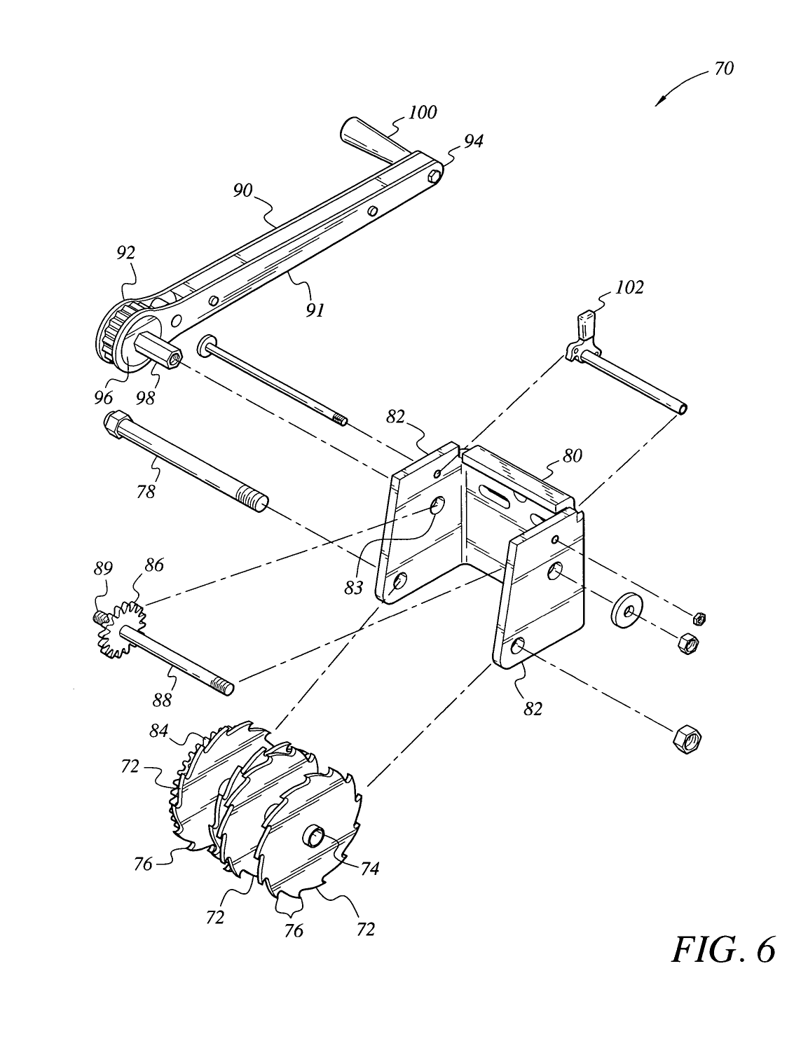

Turning now to FIGS. 5 and 6, the drive wheel assembly 70 is seen in greater detail. The drive wheel assembly 70 includes at least one toothed or spiked climbing wheel 72 disposed on a rotatable climbing wheel hub 74. In the illustrated embodiment, four (4) climbing wheels 72 are used. Each of the climbing wheels 72 of the illustrated embodiment is a flat circular disk having a plurality of sharply pointed teeth 76 disposed about the circumference of the disk. The teeth 76 are configured to grip or engage with the trunk of a tree. In the illustrated embodiment, the climbing wheel hub 74 is rotatably supported on an axle 78, the axle being supported between sidewalls 82 of a bracket 80. A hub gear 84 is disposed on one end of the climbing wheel hub 74, and is fixed to the climbing wheel hub 74 such that rotation of the gear causes rotation of the climbing wheel hub 74. The hub gear 84 is adjacent to one of the sidewalls 82. The climbing wheels 72 are similarly fixed to the climbing wheel hub 74 so that the climbing wheels 72 turn along with the climbing wheel hub 74.

A drive gear 86 is supported between the side walls 82 of the bracket 80 on a drive gear shaft 88, the drive gear shaft 88 being rotatably supported between the side walls 82 of the bracket 80. The drive gear 86 is disposed near one end of the drive gear shaft 88 so that the drive gear 82 is positioned in engagement with the hub gear 84. The drive gear 86 is fixed to the drive gear shaft 88 so that the drive gear 86 rotates with the drive gear shaft 88. An end 89 of the drive gear shaft 88 extends through an aperture 83 formed in one of the side walls 82 of the bracket 80 such that the drive gear shaft 88 may be connected to a ratchet handle assembly 90.

Ratchet handle assembly 90 comprises an elongated arm 91 having a first end 92 and a second end 94. A ratchet assembly 96 is contained within the first end 92 of the arm 91, and a handle 100 is disposed on the second end 94. A shank 98 driven by the ratchet assembly 86 extends from the first end 92 of the arm 91 perpendicular to the arm 91, and is engaged with the drive gear shaft 88 so that the drive gear 86 is driven by operation of the ratchet handle assembly 90.

A locking toggle 102 is mounted on the bracket 80 adjacent to the drive gear 86. The locking toggle 102 is pivotable between a first position, wherein the locking toggle 102 engages with the drive gear 86 to allow rotation of the drive gear 86 in a forward direction while preventing rotation of the drive gear 86 in a reverse direction, and a second position, wherein the locking toggle 102 engages with the drive gear 86 to prevent rotation of the drive gear 86 in the forward direction while allowing rotation of the drive gear 86 in the reverse direction.

It can now be recognized that operating the ratchet handle assembly 90 to turn the drive gear 86, thereby turning the hub gear 84 and climbing wheel hub 74, causes rotation of the climbing wheels 72. With the climbing tree stand 10 installed about the trunk of a tree, the rotation of the climbing wheels 72, in a first direction, causes the climbing wheels 72 to propel the climbing tree stand 10 upward along the trunk of a tree.

In an alternate embodiment of the climbing tree stand (not illustrated), circular rails are mounted to the support frame 20, and configured to encircle a tree trunk when the tree stand is mounted on a tree. A seat is slidably mounted on the circular rails that encircle the tree trunk. The seat slides along these rails so that the seat may be reoriented in any direction around the tree. A drive mechanism allows a seated hunter to position the seat around the tree trunk quickly and easily.

Wheels (not shown) may be installed on the bottom end of the support frame 20, to facilitate transportation of the climbing tree stand 10. Additionally, a telescoping handle (not shown) may be disposed on the support frame. The telescoping handle may be configured to extend from the first and second side rails 22, 24 of the support frame 20.

It is to be understood that the present invention is not limited to the embodiments described above, but encompasses any and all embodiments within the scope of the following claims.

1. A climbing tree stand, comprising:
a support frame having upper and lower ends;
a top guide removably attached to said support frame near the upper end;
a bottom guide removably attached to said support frame near the lower end;
a platform attached to the lower end of said support frame;
a climbing wheel assembly at the lower end of said support frame, the climbing wheel assembly having at least one climbing wheel adapted for engagement with the trunk of a tree; and
a lever arm having a first end and a second end, the first end having a ratchet assembly operatively coupled to said at least one climbing wheel;
whereby operation of the lever arm to rotate the at least one climbing wheel propels the climbing tree stand along the trunk of the tree.

2. The climbing tree stand according to claim 1, wherein said climbing wheel assembly further comprises a bracket having a pair of generally parallel side walls, said at least one climbing wheel being rotatably supported between the side walls.

3. The climbing tree stand according to claim 2, wherein said climbing wheel assembly further comprises a climbing wheel hub rotatably mounted between said side walls, said at least one climbing wheel being fixed on the climbing wheel hub.

4. The climbing tree stand according to claim 3, wherein said climbing wheel assembly further comprises a hub gear fixed to said climbing wheel hub.

5. The climbing tree stand according to claim 4, wherein said climbing wheel assembly further comprises a drive gear rotatably mounted on said bracket and engaged with said hub gear.

6. The climbing tree stand according to claim 5, wherein said ratchet assembly is operatively engaged with said drive gear.

7. The climbing tree stand according to claim 4, wherein said climbing wheel assembly further comprises a locking toggle disposed on said bracket and having a first position wherein the locking toggle engages with said drive gear to allow rotation of said drive gear in a forward direction while preventing rotation of said drive gear in a reverse direction, and a second position wherein the locking toggle engages with said drive gear to prevent rotation of said drive gear in the forward direction while allowing rotation of said drive gear in the reverse direction.

8. The climbing tree stand according to claim 1, wherein said top guide comprises a pair of arms removably joined to, and extending rearward from, said support frame.

9. The climbing tree stand according to claim 8, wherein said top guide further comprises a roller member disposed between said pair of arms.

10. The climbing tree stand according to claim 1, further comprising a seat bottom disposed on said support frame.

11. The climbing tree stand according to claim 1, further comprising a seat back disposed on said support frame.

12. The climbing tree stand according to claim 1, wherein each said at least one climbing wheel is a flat circular disk having a plurality of teeth formed about the circumference of the disk, the teeth being adapted for engagement with the trunk of a tree.

13. A climbing tree stand, comprising:
a support frame having upper and lower ends;
a top guide removably attached to said support frame near the upper end;
a bottom guide removably attached to said support frame near the lower end;
a platform attached to the lower end of said support frame;
a climbing wheel assembly at the lower end of said support frame, the climbing wheel assembly having at least one climbing wheel adapted for engagement with the trunk of a tree; and
means for rotating said least one climbing wheel whereby rotation of the at least one climbing wheel propels the climbing tree stand along the trunk of the tree.

14. The climbing tree stand according to claim 13, wherein said top guide comprises a pair of arms removably joined to, and extending rearward from, said support frame.

15. The climbing tree stand according to claim 14, wherein said top guide further comprises a roller member disposed between said pair of arms.

16. The climbing tree stand according to claim 13, further comprising a seat bottom disposed on said support frame.

17. The climbing tree stand according to claim 13, further comprising a seat back disposed on said support frame.

18. A climbing tree stand, comprising:
a support frame having upper and lower ends;
upper guide means for securing the upper end of said support frame support frame about a tree trunk;
lower guide means for maintaining the lower end of said support frame in alignment with the tree trunk;
a platform attached to the lower end of said support frame;
a climbing wheel assembly at the lower end of said support frame, the climbing wheel assembly having at least one climbing wheel adapted for engagement with the trunk of a tree; and
means for rotating said least one climbing wheel whereby rotation of the at least one climbing wheel propels the climbing tree stand along the trunk of the tree.
